(19) United States
(12) Patent Application Publication
(10) Pub. No.: US 2021/0190039 A1
(43) Pub. Date: Jun. 24, 2021

(54) WIND TURBINE TOWER SYSTEM FOR SECOND NATURAL FREQUENCY MODIFICATION

(71) Applicant: Siemens Gamesa Renewable Energy Innovation & Technology S.L., Sarriguren (Navarra) (ES)

(72) Inventors: Borja San Vicente Larrechi, Vitoria, ALAVA (ES); Pablo Unanua Hermoso de Mendoza, Olloki - Navarra (ES)

(21) Appl. No.: 17/263,601

(22) PCT Filed: Jul. 15, 2019
(86) PCT No.: PCT/EP2019/068978

§ 371 Date: Jan. 27, 2021

(30) Foreign Application Priority Data
Aug. 3, 2018 (ES) P201800182

(51) Int. Cl. F03D 7/02; F03D 17/00; F03D 13/30

(52) U.S. Cl. CPC F03D 7/0296; F05B 2260/964; F03D 13/30; F03D 17/00

(57) ABSTRACT

A method for second natural frequency wind turbine tower modification is provided. The method includes the steps of: a) determining the second natural frequency of the wind turbine; b) calculating the anti-node of the second natural frequency to determine the point of the wind turbine tower that suffers the greatest displacement during the second natural vibration mode; c) determining an height of the tower corresponding with the anti-node calculated in b); d) calculating a mass to be placed at the height of the tower to modify the second natural frequency considering that a heavier mass leads to a lower second natural frequency; e) placing the mass calculated in step d) at the height determined in step c).

### CROSS-REFERENCE TO RELATED APPLICATIONS

This application claims priority to PCT Application No. PCT/EP2019/068978, having a filing date of Jul. 15, 2019, which is based off of ES Application No. P201800182, having a filing date of Aug. 4, 2018, the entire contents both of which are hereby incorporated by reference.

### FIELD OF TECHNOLOGY

The following relates to a wind turbine tower system for second natural frequency modification. The modification of the second natural frequency of the tower is achieved by modifying the mass distribution of the tower.

### BACKGROUND

In the state of the art a plurality of solutions to modify, generally to mitigate or counteract, the amplitudes of several vibration modes of wind turbine towers.

Wind turbine towers have to be dynamically compatible with the remaining elements of the wind turbine (i.e. rotor, blades, etc.). Some of these elements are exciting sources that generate additional loads at a certain frequency and it essential to avoid a dynamic collision among them. For example, the rotor is a load source which rotates at a frequency known as 1P, and the blades have an individual pitch known as 3P.

The frequency of the towers, generally, decreases for higher towers having the same base diameter. At the same time, for an already designed tower, if the mass at the end of the tower (rotor and nacelle weight) the frequency is lower. Because of these reasons and due to the tendency of this technology field of increasing the measures of the rotor and the nominal power, the weight at the end of the tower has been increasing. At the same time, the height of the towers is higher in order to capture higher wind speeds.

According to what has been explained, the natural frequencies of the wind turbine towers vary depending on a plurality of different parameters in a wide range, from a high frequency in small towers to a low frequency in high towers.

Small height towers with high frequencies do not usually have dynamic collisions since their natural frequency tends to be higher than the 1P. However, in towers that are higher and/or have higher power or a bigger generator the frequencies decrease and they can collide with 1P. When this situation occurs, and the height of the tower cannot be modified, the tower structure has to be modified by changing the distribution of the mass of the tower so the first natural frequency does not collide with the 1P. That means that the structure of the tower will no longer be the optimal and it will be more expensive.

In document US2016252079 it is disclosed a method of damping wind turbine tower oscillations. The method comprises connecting a bag of material or liquid to a tower component at a first lateral distance away from a tower wall. The bag is also suspended from the tower component by a first vertical distance. The height of the tower component is known such that the first vertical distance corresponds to a particular height within the tower. The first lateral distance, first vertical distance, and mass of the bag are such that the bag is configured to hit said tower wall during oscillations in said wind turbine tower, in order to damp said oscillations in said wind turbine tower.

Document WO2012003832 discloses a wind turbine comprising a detuner. The drive train of the wind turbine comprises at least one rotatable driving element configured to provide at least one torsional resonance frequency in the drive train, a first detuner having at least one first mass element with a first mass inertia and at least one first elastic element with first elastic properties and a second detuner having at least one second mass element with a second mass inertia and at least one second elastic element with second elastic properties. The first and second mass elements and first and second elastic elements are arranged to rotate during operation of the wind turbine thus influencing the torsional resonance frequency.

It is also known document WO2017144061 which discloses a method for damping oscillation of a tower of a wind turbine. The pitch angle of each of the one or more rotor blades is individually adjustable, and the method comprises damping the oscillation of the tower by pitching each rotor blade individually according to tower damping pitch control signals. Each tower damping pitch control signal comprises a first periodic component, where a first frequency of the first periodic component corresponds to a frequency difference between a tower frequency of the oscillation of the tower and a rotor frequency of a rotation of the rotor, and where a second periodic component has been reduced or removed. A second frequency of the second periodic component corresponds to a frequency sum of the tower frequency and the rotor frequency.

Also document US2013280064 describes a wind turbine with adjustable damper including a movable mass. The damper is adapted for variably adjusting a frequency response of the wind turbine. And document US2013195653 describes a wind turbine vibration damping method in which a damper is adjusted to damp vibration in a natural frequency of a wind turbine and an additional damper is adjusted to dam vibration in a variable frequency of turbulent wind flowing into the wind turbine and/or a frequency of a rotation speed of a wind-turbine blade, and a pitch-angle control portion provided with a correction portion which adjusts a damping frequency of the additional damper which obtains the damping force by changing the pitch angle of the wind-turbine blade.

All the described solutions imply the use of dampers.

Also, when a wind turbine is designed, dynamical viability of the complete turbine must be checked as there are movable parts that could excite some components at some of its natural frequencies.

One of the most important checks to be made when designing the tower is to analyze if the first and second tower natural frequencies are excited by rotor and blade excitation frequencies, known as 1P, 3P and 6P (second multiple of the blade pitch 3P).

In the state of the art, when there is collision between the tower second natural frequency and an excitation frequency, the problem is solved by modifying the tower structure to change this second tower natural frequency. This means, moving the tower from its optimal (cost-efficiency) structural design to a not optimal one. These structural changes imply adding steel to the tower, and/or modifying the stiffness distribution by means of diameter changes. All these changes imply an extra cost from the optimal tower design.

### SUMMARY

An aspect relates to a wind turbine tower system for second natural frequency modification. In this case the modification of the second natural frequency of the tower is achieved by modifying the mass distribution of the tower.

With embodiments of this invention the collisions between the second vibration modes with possible exciting frequencies, as for example the 6P, are avoided. This solution is achieved in an efficient way and minimizing the modification of the first natural frequency of the tower.

An important advantage of embodiments of the present invention is that it avoids collision problems that could appear when modifying the frequency of the tower.

That is to say, embodiments of the invention solve efficiently the problem generated when a second natural frequency of a tower is in collision with any excitatory frequency from the wind turbine tower.

By using a specific mass placed at a specific height near the center of the tower, the second natural frequency of the tower can be modified, without modifying significantly the first natural frequency. Therefore, the problems of the second natural frequency collisions are solved without modifying the tower structural design.

To achieve this modification, embodiments of the invention describe a method comprising a step of placing a mass which weight depends on the mass of the wind turbine and the percentage of desired decrease in the second vibration mode.

The mass has to be placed at a specific height in the tower so the effect is achieved in the most efficient way. This height corresponds to the anti-node of the second vibration mode of the tower. The mentioned height is different for each tower since it depends on the specific distribution of masses and the rigidity of the tower.

The method comprises a first step of determining the second natural frequency of the wind turbine and afterwards a step of using the second natural frequency to calculate the anti-node of said second natural frequency. The anti-node determines the point of the wind turbine tower that remains invariant during the second natural vibration mode.

The height of the tower in which the mass has to be placed corresponds with the height between the base of the tower and the anti-node point. The mass to be placed has to be calculated considering that a heavier mass leads to a lower second natural frequency. The mass also depends on how much is going to be modified the second natural frequency of the wind turbine tower, the rigidity of the tower, the mass of the tower and the top head mass comprising the mass of the rotor and of the nacelle.

Lastly, the method comprises a step of placing the mass previously calculated at the height corresponding to the anti-node of the second natural frequency.

An aspect relates to a wind turbine tower comprising a mass placed at the anti-node of the second natural frequency. The mass is such as to modify a previous wind turbine natural frequency.

### BRIEF DESCRIPTION

Some of the embodiments will be described in detail, with reference to the following figures, wherein like designations denote like members, wherein:

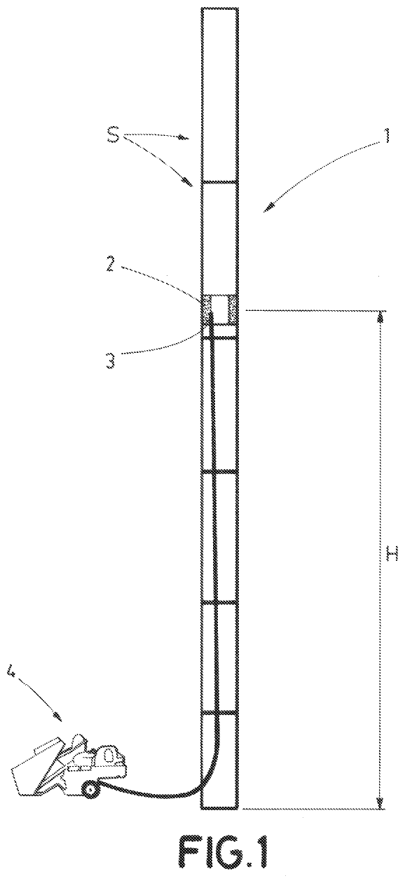

FIG. 1. shows a wind turbine tower with the system of the invention; and

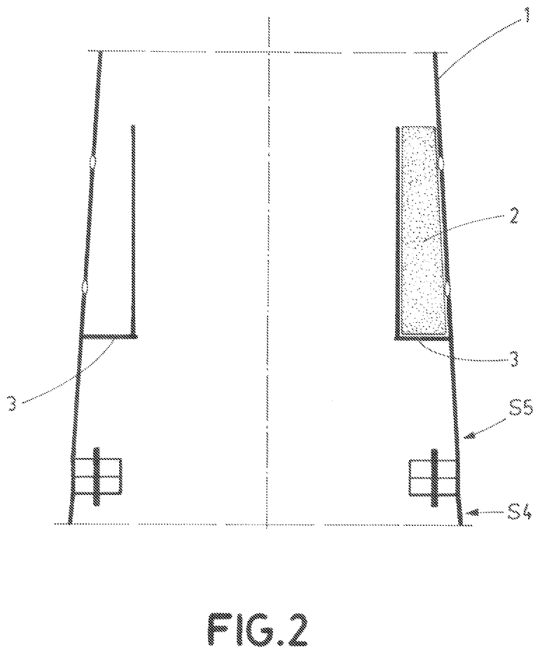

FIG. 2. shows a zoom view of the section of the tower in which the mass is added.

### DETAILED DESCRIPTION

A method for second natural frequency wind turbine tower modification to avoid the collisions between the second vibration modes with possible exciting frequencies of the wind turbine is proposed.

The method comprises the following steps:

a) determining the second natural frequency of the wind turbine;
b) calculating the anti-node of the second natural frequency to determine the point of the wind turbine tower (1) that remains invariant during the second natural vibration mode;
c) determining a height (H) of the tower (1) corresponding with the anti-node calculated in b);
d) calculating a mass (2) to be placed at said height (H) of the tower to modify the second natural frequency considering that a heavier mass (2) leads to a lower second natural frequency;
e) placing the mass (2) calculated in d) at the height (H) determined in c).

The step of determining the second natural frequency of the wind turbine considers the frequencies of the wind turbine with all its components. It is to be considered the whole wind turbine with the rotor and nacelle and not only the frequencies of the tower (1). This is essential since the wind turbine will comprise all its components when completely installed and the possible collisions with the second natural frequency will appear in that situation.

The anti-node is a point of the tower (1) which is placed between two invariant nodes, that is to say, between two points that do not displace. The anti-node to be found in step b) is to be found approximately at a 0.6*H (around the 60% of the height of the tower). The exact location can be obtained by the deflection of the second vibration modes. The anti-node can be determined analytically or with numerical simulation.

When the anti-node has been calculated, the next step is to determine the height (H) of the tower (1) in which the anti-node has been found. Said height (H) corresponds to the distance between the anti-node and the base of the tower (1).

Step d) of calculating a mass (2) to be placed is done considering how much is going to be modified the second natural frequency of the wind turbine tower (1), the rigidity of the tower (1), the mass of the tower (1) and the top head mass comprising the mass of the rotor and of the nacelle.

As explained above, the rotor and nacelle have to be considered in the method because both elements are present when the wind turbine is working and thus, they are present when the possible collisions between vibration modes appear.

The step d) of calculating the mass (2) to be placed in the anti-node is done with numerical simulation or according to Rayleigh method. The determination of the mass (2) can be done with iterative calculations, for example, it can be simulated a 1 ton mass (2) placed in the anti-node and the natural frequencies of the wind turbine are calculated.

Then, considering that placing a higher mass (2) leads to a decrease in the second natural frequency, the simulation can be repeated with a higher or a lower mass (2) according to the modification to be made. When a lower second natural frequency is to be achieved, the mass has to be increased.

In an exemplary embodiment of the invention the method further comprises a sub-step of placing a receptacle (3) at the height (H) determined in step c) and a sub-step of filling the receptacle (3) with a mass (2) as calculated in step d).

In FIG. 1 it can be appreciated a wind turbine tower (1) section with a receptacle (3), placed at the height (H) corresponding to the anti-node. Said figure represents an embodiment of the invention in which the receptacle (3) is a sandbox and the mass (2) with which the receptacle (3) is filled is sand. It can be appreciated also a sand pump (4) with which the sand is pumped to the receptacle (3).

In another embodiment of the invention step e) of placing the mass (2) at the height corresponding with the anti-node is done by welding the mass (2) in the interior of the tower (1).

When the method is going to be performed in a wind turbine tower that is manufactured in sections (S), step d) is performed placing the mass (2) in the section (S) of the tower (1) corresponding with the specific location of the height (H) of the tower determined in step c). In FIG. 2 it can be appreciated a zoom view of the section of the wind turbine tower in which the receptacle (3) is placed.

A further aspect relates to provide a wind turbine tower (1) that comprises a mass (2) placed at a height (H) of the tower corresponding to the anti-node of the second natural frequency. The mass (2) comprised by the tower being a mass (2) causing a desired modification of a previous wind turbine second natural frequency.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for second natural frequency wind turbine tower modification wherein it comprises the steps of:
a) determining the second natural frequency of the wind turbine;
b) calculating the anti-node of the second natural frequency to determine the point of the wind turbine tower that suffers the greatest displacement during the second natural vibration mode;
c) determining a height of the tower corresponding with the anti-node calculated in b);
d) calculating a mass to be placed at said height of the tower to modify the second natural frequency considering that a heavier mass leads to a lower second natural frequency; and
e) placing the mass calculated in step d) at the height determined in step c).

2. The method for second natural frequency wind turbine tower modification according to claim 1 wherein the step d) is calculated considering how much is going to be modified the second natural frequency of the wind turbine tower, the rigidity of the tower, the mass of the tower and the top head mass comprising the mass of the rotor and of the nacelle.)

3. The method for second natural frequency wind turbine tower modification according to claim 1 wherein the step b) is calculated analytically or with numerical simulation.

4. The method for second natural frequency wind turbine tower modification according to claim 1 the step d) is calculated with numerical simulation or according to Rayleigh method.

5. The method for second natural frequency wind turbine modification according to claim 1 wherein it further comprises a sub-step of placing a receptacle at the height determined in step c) and a sub-step of filling the receptacle with a mass as calculated in step d).

6. The method for second natural frequency wind turbine modification according to claim 5 wherein the receptacle is a sandbox and the mass which the receptacle is filled is sand.

7. The method for second natural frequency wind turbine modification according to claim 1 wherein step e) is done by welding the mass in the interior of the tower).

8. The method for second natural frequency wing turbine modification according to claim 1 wherein the wind turbine tower is manufactured in sections and step d) is performed placing the mass in the section of the tower corresponding with the specific location of the height of the tower determined in step c).

9. A wind turbine tower wherein it comprises a mass placed at a height of the tower corresponding to the anti-node of the second natural frequency said mass causing a modification of a previous wind turbine second natural frequency.
